(19) United States
(12) Patent Application Publication
(10) Pub. No.: US 2014/0348572 A1
(43) Pub. Date: Nov. 27, 2014

(54) UNIVERSAL JOINT AND VARIABLE STRUCTURE

(71) Applicants: Teruo Matsuzawa, Nomi-shi (JP); Yohei Yokosuka, Nomi-shi (JP)

(72) Inventors: Teruo Matsuzawa, Nomi-shi (JP); Yohei Yokosuka, Nomi-shi (JP)

(73) Assignee: JAPAN ADVANCED INSTITUTE OF SCIENCE AND TECHNOLOGY, Nomi-shi, Ishikawa (JP)

(21) Appl. No.: 14/115,517

(22) PCT Filed: May 7, 2012
(86) PCT No.: PCT/JP2012/061638

§ 371 Date: Jan. 17, 2014

(30) Foreign Application Priority Data
May 8, 2011 (JP) 2011-103910

(51) Int. Cl. F16C 11/06; E04B 1/19; E04B 1/58

(52) U.S. Cl. CPC F16C 11/06; E04B 1/58; E04B 1/1906
USPC 403/57

(57) ABSTRACT

The object is to provide a universal joint that, has a secure range of motion, does not deviate from the center of rotation, and does not generate bending moments between itself and a joint that links a plurality of movable members. A plurality of movable members (3A-3F and 3a-3f) and a spherical member (2) that links the plurality of movable members are provided, curved node sections (q) are formed on the movable members and are brought into contact with the spherical member (2), and by causing one of the plurality of movable members (3A) to rotate such that the curved node section thereof rotates along the surface of the spherical member (2), another one of the plurality of movable members (3B) is caused to rotate along the surface of the spherical member.

### TECHNICAL FIELD

The present invention relates to a universal joint and particularly relates to a universal joint that links a plurality of movable members and a variable structure connected to the universal joint.

### BACKGROUND ART

Universal joints have been widely used for machine control technology such a steering techniques. Universal joints have two members joined at a variable angle. Such universal joints include a hook joint such a Cardin joint having two movable member ends connected with a cross pin, a ball universal joint including a ball and socket joint, and a ball joint magnet having a ball and a movable member that are joined by a magnetic force.

### PRIOR ART DOCUMENT

### Patent Document

Patent Document 1 describes that a ball joint configured to be swaged over a ball formed on the end of a movable member, e.g., a piston. Patent Document 2 describes a pin joint that moves a movable member with a curved member. Patent Document 3 describes a running torque transmission joint that connects one shaft to the other shaft to transmit a running torque. Moreover, known a truss structure called variable geometry trust (VGT) applied to a building structure.
Patent Document 1 is U.S. Pat. No. 2,708,591
Patent Document 2 is JP-H07-228960A1
Patent Document 3 is JP-H09-060649A1
Non-Patent Literature 1: System/control/information, Vol. 45, No. 2, pp 82-89, 2001

### BRIEF SUMMARY OF THE INVENTION

### Problems the Invention Intends to Solve

However, conventional universal joints cannot obtain a range of motion for a large number of movable members. Furthermore, in a conventional universal joint, a large axial force disadvantageously generates a bending moment at a nodal point.

Specifically, the number of movable members cannot be increased to four, eight, twelve, and so on. Even if the number of movable members can be increased, a bending moment may be generated at a nodal point. For example, in application of a VGT (a variable geometry truss: a metallic framework) to a nodal portion, a plurality of frames are connected at the top of the VGT and thus generate a bending moment at the top. Unfortunately, a metallic structure like a frame may cause a metal fatigue between the structure and a spherical member because of driving of a driving member.

In view of the above, the present invention to provide a universal joint that, even if multiple movable members are provided, can obtain a range of motion without deviating from the center point of rotation or generating a bending moment between the movable members and a joint for linking the movable members, and a variable structure including the multiple connected universal joints.

### Means for Solving the Problems

In order to solve the problems, a universal joint, comprising: a plurality of movable members; a spherical member that links the movable members; a cover member that brings the movable members into contact with the spherical member; wherein the movable member has a curved nodal portion in contact with the spherical member, and any one of the movable members is moved or rotated along the surface of the spherical member with the curved nodal portion.

According to the present invention, the curved nodal portion is formed on the engaging surface of the movable member and is in contact with the spherical member. In the case of a large number of movable members, using a large spherical member allows the provision of the corresponding number of movable members. The curved nodal portion of one of the movable members is moved or rotated along the spherical member. Thus, even a large number of movable members can be driven without deviating from the center point of movement or rotation.

The universal joint according to the present invention is characterized in that the curved nodal portion of the movable member is larger in diameter than the movable member and the cover member is movable or rotatable along the surface of the curved nodal portion. In this case, some of the curved nodal portions of the movable members may be brought into contact with the spherical member with the cover member while the curved nodal portions of the other movable members may not be brought into contact with the spherical member. Alternatively, the cover member may operate with the movable members.

According to the present invention, depending upon the location of the cover member, one of the movable members can be rotated while another one of the movable members is not rotated. If the movable member operates with the cover member, the cover member can be rotated along the surface of the curved nodal portion. Thus, the movable member linked with the cover member and the other movable members move or rotate along the surface of the spherical member without interfering with each other.

The universal joint according to the present invention is characterized in that the movable members include at least two pairs of members: a first pair of movable members and a second pair of movable members, and the cover member includes a first cover member that brings one of the movable members of the first pair and the other movable member of the second pair into contact with the spherical member, and a second cover member that brings the other movable member of the first pair and one of the movable members of the second pair into contact with the spherical member.

According to the present invention, for example, in case of the two pairs of members, which are the first pair of movable members and the second pair of movable members, are disposed at intervals of 90 degree on the surface of the spherical members such the pairs are respectively located along a vertical line and a horizontal line of the spherical member, only one of the first and second pairs of movable members can be rotated.

The universal joint according to the present invention is characterized in that further comprising: a cylindrical member covering each of the movable members; wherein the cylindrical member is connected that is allowed a rotation of the cover member.

According to the present invention, the cylindrical member covering one of the movable members is operated so as to rotate the other movable members with the cover member connected to the cylindrical member.

The universal joint according to the present invention is characterized in that the universal joint according to claim 1, wherein the movable members are disposed radially around the spherical member, or the movable members are disposed with point symmetry around the spherical member, or the movable members are disposed with line symmetry around the spherical member.

According to the present invention, the movable members disposed radially or with point symmetry or line symmetry can be moved in a coordinated manner. Specifically, when one of the movable members is rotated, another one of the movable members is preferably moved or rotated with respect to the spherical member in response to the rotation.

### Effects of the Invention

According to the present invention, even a large number of movable members can be rotated along the surface of the spherical member without deviating from the center point of rotation. The number of movable members can be increased and a range of motion can be ensured by expanding the surface area of the spherical member.

According to the present invention, the movable members are radially disposed with respect to the spherical member or are disposed with point symmetry or line symmetry. Thus, the movable members can be moved by an equal angle, the movable members can be driven so as to transform in a certain direction, the pair of opposed movable members can be symmetrically driven, one of the pairs of opposed movable members can be driven while the other pair of movable members is not driven, or the movable members can be freely and driven in a separate manner. This can achieve a structure generating no bending moment between the movable members and the spherical member linked with the movable members, regardless of how the movable members are driven.

According to the present invention, since the nodal points as contact points are free, for example, even if the movable members and the spherical member are made of metals, the free nodal points as contact points do not generate a bending moment. For example, if a three-dimensionally transformed component like a dome ceiling is formed in a tent supported with a frame, a durable truss structure can be provided for an extendable building structure. Furthermore, the nodal points such curved nodal portions are free and thus even in application to a damping/base isolation structure or like, the present invention can be effectively used for an active control technique involving the transformation of the structure.

The following advantages can be obtained:

### (Productivity)

The number of kinds of curved structure members can be reduced. Even if a curved structure is designed with varying angles of members at all nodal points, the curved structure can be composed of an identical joint mechanism.

### (Work Efficiency)

The number of temporary works can be reduced. A three-dimensional dome building to be constructed is temporarily assembled on a flat surface to adjust the lengths of the members, allowing the three-dimensional construction of the dome building.

### (Expandability)

An additional structure can be optionally produced using the freely changing angles of the movable members. Since a bending moment is not generated, a longer life cycle can be obtained.

### (Adaptability)

A structure changing depending upon the environment can be produced. If a structure is designed with a varying internal volume, the internal volume is reduced in a summer period having a large energy load. Thus, the structure can change depending upon the environment.

### (Efficiency)

The present invention is suitable for the joints of a parallel-link mechanism. The mechanism can be controlled by the direct action of the movable member unlike in a serial link mechanism under torque control. This can efficiently transform the universal joint.

### (Novelty)

An organic shape can be formed with an extended range of design. A durable structure, e.g., the large roof of a spacious construction can be obtained while attracting publicity.

### BRIEF DESCRIPTION OF THE DRAWINGS

FIG. 1 is an explanatory drawing of the principle and configuration of a universal joint according to the present invention.

FIG. 2 is an explanatory drawing of the principle and configuration of the universal joint according to the present invention.

FIG. 3 is an explanatory drawing of the principle and configuration of the universal joint according to the present invention.

FIG. 4 is an explanatory drawing of the principle and configuration of the universal joint according to the present invention.

FIG. 5A is a perspective view illustrating a universal joint according to a first embodiment of the present invention.

FIG. 5B is a perspective view showing the component configuration of the universal joint.

FIG. 6 is an explanatory drawing of the relationship between a movable member and a cover member according to the first embodiment.

FIG. 7 is an explanatory drawing of the internal configuration of a cylindrical member according to the first embodiment.

FIG. 8 is an explanatory drawing of a layout example of the movable member according to the first embodiment.

FIG. 9 is a perspective view illustrating a comparative example for explaining the effect of the first embodiment.

FIG. 10A is a perspective view for explaining an application example according to the first embodiment.

FIG. 10B is a perspective view showing the component configuration of the application example.

FIG. 11 is an explanatory drawing of the relationship between the movable member and the cover member according to the first embodiment.

FIG. 12A is a perspective view illustrating a universal joint according to a second embodiment of the present invention.

FIG. 12B is a perspective view showing the component configuration of the universal joint.

FIG. 13A is a bottom view of a universal joint according to a third embodiment of the present invention.

FIG. 13B is a side view of the universal joint according to a third embodiment of the present invention.

FIG. 13C is a perspective view of the universal joint according to a third embodiment of the present invention.

FIG. 13D is a plan view of the universal joint according to a third embodiment of the present invention.

FIG. 14 is a perspective view for explaining the operation of the universal joint according to the third embodiment.

FIG. 15 is a perspective view showing the component configuration of the third embodiment.

FIG. 16 is an explanatory drawing of an application example of the embodiment.

FIG. 17 is an explanatory drawing of an application example of the embodiment.

FIG. 18 is an explanatory drawing of an application example of the embodiment.

FIG. 19 is an explanatory drawing of a variable geometry truss structure.

FIG. 20 is an explanatory drawing of a variable geometry truss structure.

FIG. 21 is an example according to the second embodiment.

FIG. 22A is an explanatory drawing showing motions according to the second embodiment, in which short movable members move or rotate along a spherical member while keeping a constant distance from long movable members such that the long movable members come closer to each other in a sliding manner.

FIG. 22B is an explanatory drawing showing motions according to the second embodiment, in which short movable members move or rotate along a spherical member while keeping a constant distance from long movable members such that the long movable members come close to each other in a sliding manner.

FIG. 22C is an explanatory drawing showing motions according to the second embodiment, in which the short movable members move or rotate along the spherical member while keeping a constant distance from the long movable members such that the long movable members come closer to each other in a sliding manner.

FIG. 22D is an explanatory drawing showing motions according to the second embodiment, in which the short movable members move or rotate along the spherical member while keeping a constant distance from the long movable members such that the long movable members come closer to each other in a sliding manner.

FIG. 22E is an explanatory drawing showing motions according to the second embodiment, in which the short movable members move or rotate along the spherical member while keeping a constant distance from the long movable members such that the long movable members come closer to each other in a sliding manner.

FIG. 23 is an explanatory drawing of the motions of a structure including connected universal joints according to the second embodiment.

FIG. 24A is an explanatory drawing of the motions of a variable structure including the connected universal joints according to the second embodiment of the present invention.

FIG. 24B is an explanatory drawing of the motions of the variable structure including the connected universal joints according to the second embodiment of the present invention.

FIG. 24C is an explanatory drawing of the motions of the variable structure including the connected universal joints according to the second embodiment of the present invention.

FIG. 24D is an explanatory drawing of the motions of the variable structure including the connected universal joints according to the second embodiment.

### DETAILED DESCRIPTION OF THE INVENTION

Hereinafter, specific modes for carrying out the present invention will be explained by using drawings.

(The Principle and Configuration of the Present Invention)

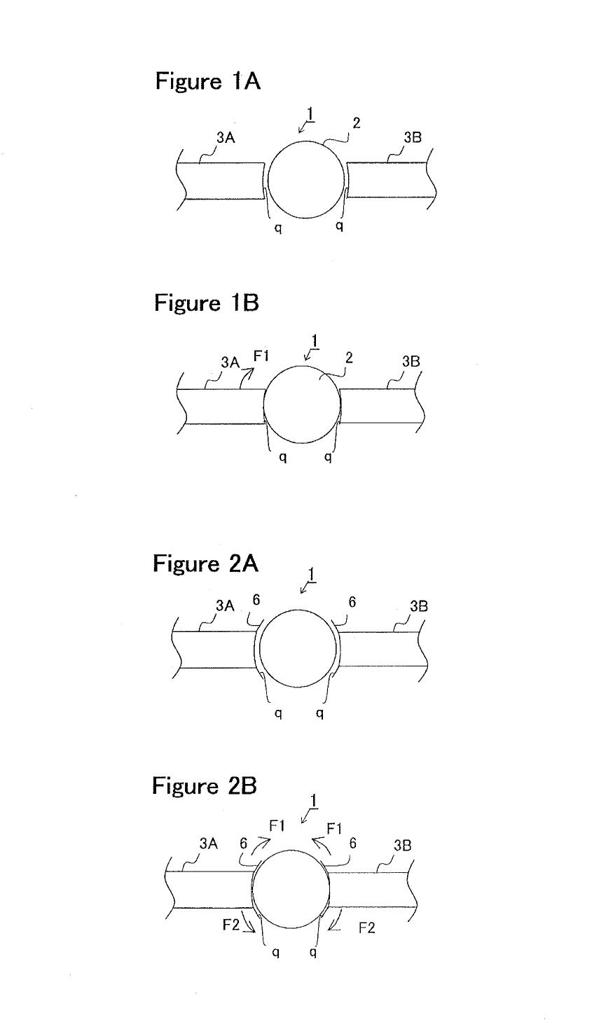

FIG. 1 shows the principle and configuration of a universal joint according to the present invention.

The present invention includes a spherical member 2 and a plurality of movable members 3A, 3B, and so on. The movable member 3A is driven by the movable member 3B with the spherical member 2. In this explanation, the two movable members 3A and 3B are provided. The number of movable members may be two or more and an even number or an odd number.

The movable members 3A and 3B each have a curved nodal portion q with a predetermined curvature on one end. In this case, the curvature of the curved nodal portion q on each of the movable members 3A and 3B is larger than that of the spherical shape of the spherical member 2. The curvature of the curved nodal portion q may be equal to or smaller than that of the spherical member 2. As shown in FIG. 2A and FIG. 2B, the curved nodal portion q may be larger in diameter than the movable members 3A and 3B and come into contact with the spherical member 2.

The curved nodal portions q of the movable members 3A and 3B are pressed to the surface of the spherical member 2 by a cover member 4, which will be described later. Thus, the movable member 3A driven in contact with the spherical member 2 (arrows F1, F2) is rotated along the surface of the spherical member 2. Arrows F1 and F2 indicate the opposite rotation directions of the movable members 3A and 3B. The movable members 3A and 3B rotated along F1 and F2 come closer to each other from the positions of FIG. 1.

The ball-like spherical member 2 has the effect of transmitting the compressive force like a sliding force of the movable member. The spherical member 2 does not move. The movable members 3A and 3B and the spherical member 2 can come into contact with each other but are not connected to each other, generating no bending moment between the movable members 3A and 3B and the spherical member 2 linked with the movable members 3A and 3B.

In FIG. 2, the two movable members 3A and 3B each have a ring as curved nodal portion 6. Both surfaces of the ring as curved nodal portion 6 are curved and are larger than the diameters of the movable members 3A and 3B. Thus, the movable member 3A is rotated along the surface of the spherical member 2 direction arrows F1 and F2 and is brought closer to or separated from the movable member 3B with respect to the rotation of the spherical member 2. A pair of movable members 3C and 3D is provided in addition to the pair of movable members 3A and 3B and they are structured to behave in a similar manner. Specifically, an angle between the movable member 3A and the movable member 3B that is next to the movable member 3C adjacent to the movable member 3A is freely changed while keeping an equal angle between the movable member 3A and the movable member 3C adjacent to the movable member 3A. The present inventor calls the joint “alternately universal joint” because a rotation is allowed for the pair of movable members 3A and 3B. In the alternately universal joint, the pair of movable members 3A and 3B and the pair of movable members 3C and 3D are rotated with an equal traveling distance. According to this principle, subsequent embodiments will be also configured as alternately universal joints.

In FIG. 4, the pairs of four movable members 3A to 3D with the rings as curved nodal portions 6 are provided on the surface of the spherical member 2. The pair of movable members 3A and 3B and the pair of movable members 3C and 3D are evenly spaced so as to have point symmetry with respect to the spherical member 2. From this position, the movable members come closer to each other or return to the original positions. A cover member 4 (4a, 4b) is disposed between the pair of movable members 3A and 3B and the pair of movable members 3C and 3D. The cover member 4 is rotatably provided along the surfaces of the rings as curved nodal portions 6 and is connected to the pair of movable members 3A and 3B or the pair of movable members 3C and 3D. For example, the pair of movable members 3A and 3B are rotated so as to approach each other while the pair of movable members 3C and 3D are stopped. In other words, a rotation direction arrow F1 of the movable member 3A of the pair of movable members 3A and 3B also rotates the movable member 3B direction arrow F2 through the cover member 4, bringing the movable members 3A and 3B closer to each other. Thus, at least two movable members can be provided. As the ball-like spherical member 2 increases in size, a larger number of movable members 3A to 3D can be provided on the surface of the spherical member 2. The movable members 3A and 3B linked with the cover member 4 that further explaining the four first and second cover members 4a and 4b evenly spaced on the outer periphery of the spherical member 2) are configured to rotate along the surfaces of the rings as curved nodal portions 6. Thus, the movable members 3A and 3B and the movable members 3C and 3D rotate along the surface of the spherical member 2 without interfering with each other.

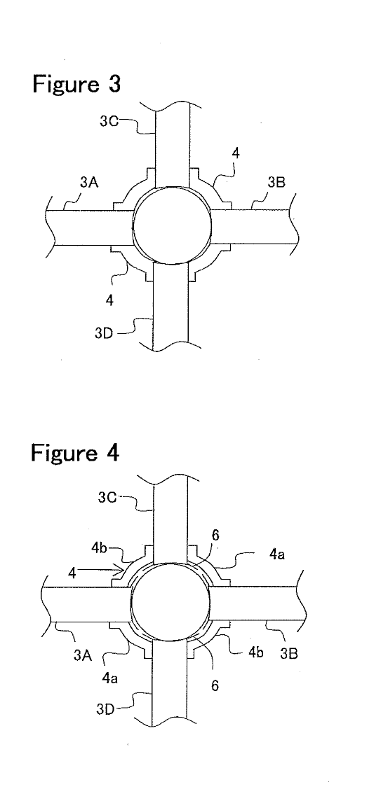

As shown in FIG. 3, without the rings as curved nodal portions 6, the movable member 3A can be rotated along the surface of the spherical member 2 direction arrows F1, F2 so as to approach or separate from the movable member 3B with respect to a rotation of the spherical member 2.

### First Embodiment

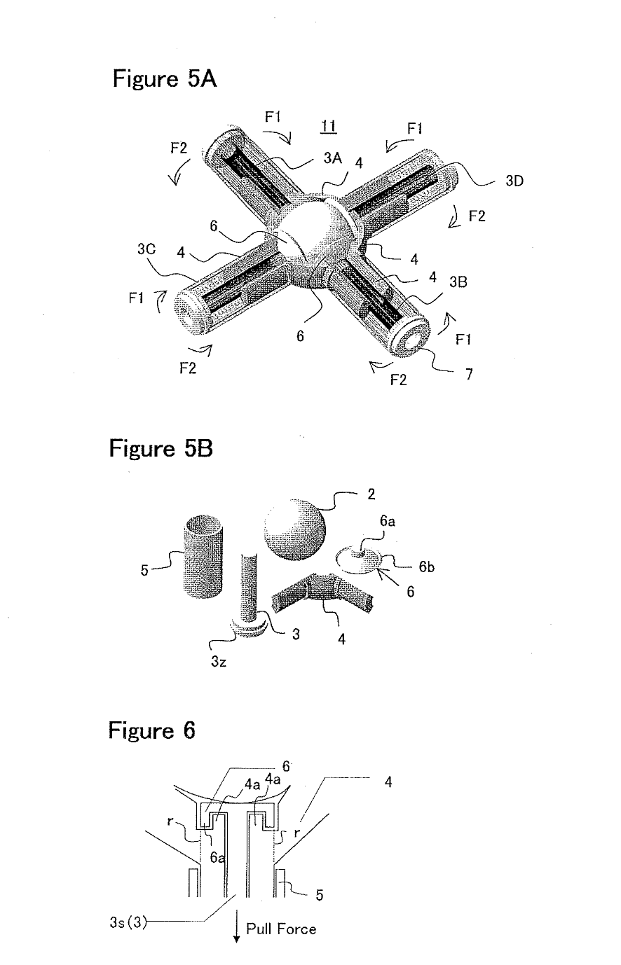

FIG. 5A is a perspective view showing a universal joint 11 according to a first embodiment. FIG. 5B is a component configuration diagram of the universal joint 11 according to the first embodiment.

In the present embodiment, the universal joint 11 includes four movable members 3A to 3D, a spherical member 2 that links the movable members 3A to 3D, and cover members 4 that bring the movable members 3A to 3D into contact with the spherical member 2. The movable members 3A to 3D have curved nodal portions as rings 6 near the spherical member. The shaft center of each of the movable members 3A to 3D has a rod member as shaft 3. The cover member 4 has a V-shaped member as wing on one end. The cover member 4 is disposed among the movable members 3A to 3D with its V-shaped left and right sides pressing the curved members as rings 6 of the movable members 3A to 3D, which are adjacent to the cover member 4, to the spherical member 2. Moreover, cylindrical members as pipes 5 cover the respective movable members 3A to 3D. The cylindrical member as pipe 5 and the cover member 4 are connected to each other while allowing a rotation of the cover member. The cover member 4 and the curved nodal portion 6 are not connected to each other and the cover member 4 presses the adjacent curved nodal portion 6 from the outer periphery. The ring as curved nodal portion 6 has a cylindrical protrusion 6a at the center of the ring 6 and a protrusion 6b around the outer circumference of the ring 6. The movable member 3 cannot be removed between the protrusions 6a and 6b. The top and bottom of the spherical member 2 have areas as gaps not containing the cover member 4, allowing a rotation of the cover member 4.

According to the present embodiment, at a nodal point where the four movable members 3A to 3D are connected, an equal angle is kept between one of the movable members and the adjacent movable member; meanwhile, an angle between the movable member and the movable member next to the adjacent movable member can be freely changed. In other words, a rotation direction arrow F1 of the movable member 3A of the pair of movable members 3A and 3B also rotates the movable member 3B direction arrow F2 through the cover member 4, bringing the movable members 3A and 3B closer to each other, while the pair of movable members 3C and 3D are stopped. Furthermore, a rotation direction arrow F1 of the movable member 3C of the pair of movable members 3C and 3D also rotates the movable member 3D direction arrow F2 through the cover member 4, bringing the movable members 3C and 3D closer to each other, while the pair of movable members 3A and 3B are stopped. The present inventor calls such a rotation “the relationship of a rotational sliding pair”.

The constituent elements as component configurations do not need to be independent from one another and are preferably combined. For example, the cylindrical member 5 and the rod member 3 are preferably combined so as to be aligned with each other in the transformation of the movable members 3A to 3D. One of the wings 4 and the cylindrical member 5 may be joined to each other but in this case, the other wing 4 needs to be independent from the cylindrical member 5. Furthermore, the curved nodal portion 6 and the rod member 3 may be combined.

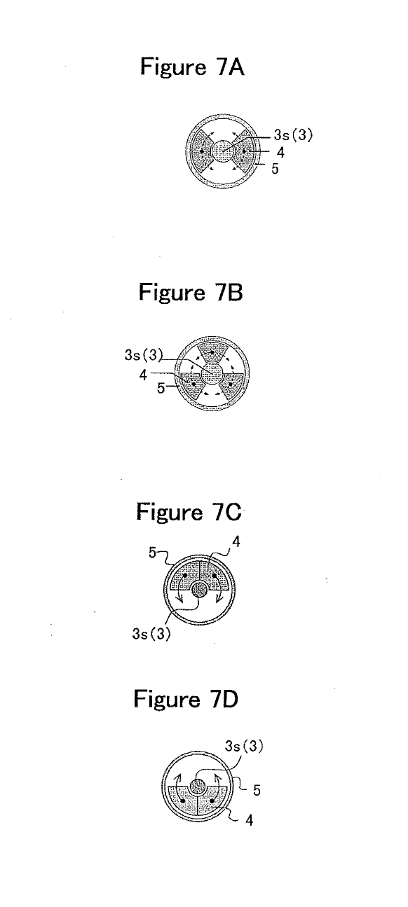

FIG. 7 shows an example of the curved member 6 and the rod member 3. A plurality of wings evenly spaced around the rod member 3 may be covered with the cylindrical member 5.

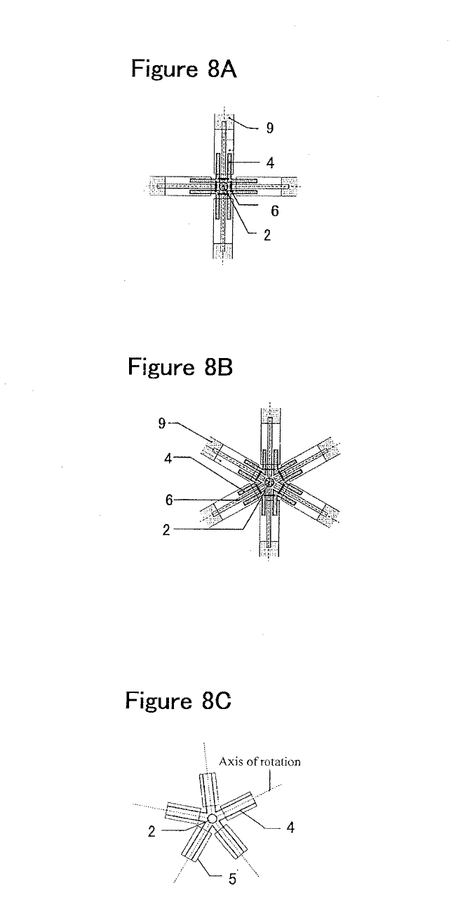

The present embodiment described an example of the four movable members (see FIG. 8A). Alternatively, six shafts (see FIG. 8B), five shafts, or an odd or even number of shafts may be provided (see FIG. 8C). Symbol 9 is spacers.

Engagement such protrusion and groove for transmitting a tensile force applied to the movable member as rod member needs to be prepared between the cylindrical member 5 and the wing 4. Preferably, the cylindrical member 5 is a protrusion and the wing is a groove in consideration of the thickness of the member.

A coil introduced into the cylindrical member 5 can achieve a mechanism with a restoring force. Alternatively, a viscous fluid introduced into the cylindrical member 5 can achieve a mechanism with a buffer effect.

In the present embodiment, the wing 4 is a member resistant to a tensile force applied to the movable member. The wings 4 are disposed around the cylindrical member 5, and at least two of the wings 4 are considered to be resistant due to a shearing resistance on two surfaces as symbol r along dotted lines (see FIG. 6).

One end faces of the movable members 3A to 3D can be formed as nodal points q having curved shapes, allowing the movable members 3A to 3D to be connected via the cover members.

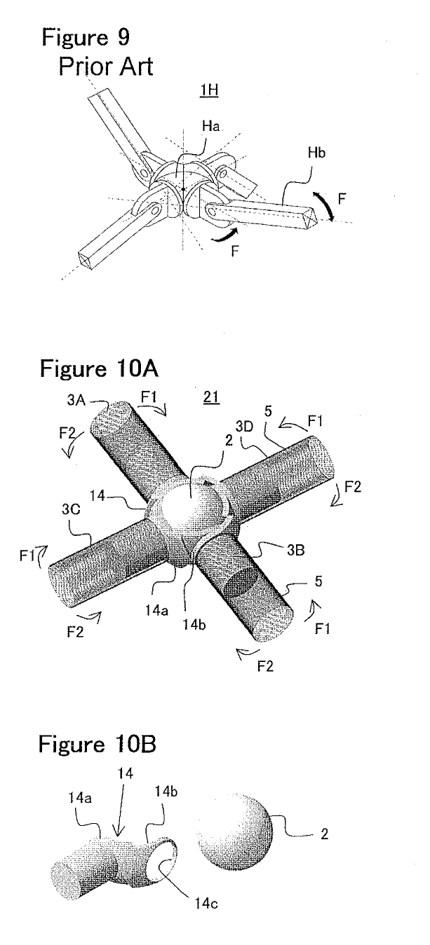

FIG. 9 is a perspective view showing a hinge joint 1H as a comparative example. The hinge joint 1H is a comparative example of the first embodiment and includes four movable members Hb and a spherical member Ha that are connected to each other. The four movable members Hb and the spherical member Ha are made of metals. The four movable members Hb driven in the comparative example generates a bending moment at a connected point. The metallic movable members Rb may cause a metal fatigue.

Unlike the hinge joint 1H, the universal joint 11 of the present embodiment brings the curved nodal portion q into contact with the spherical member 2, thereby preventing a bending moment on the curved nodal portion q without deviating from the center of rotation.

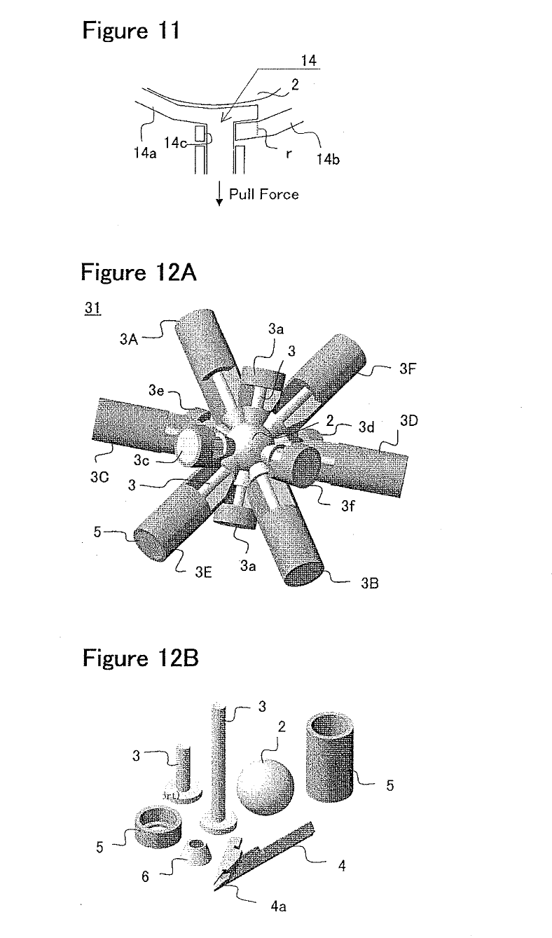

FIG. 10 and FIG. 11 illustrate a universal joint 21 according to an application example of the first embodiment.

In the application example 21, a cover member 14 includes a first cover 14a and a second cover 14b having a through hole 14c through which another adjacent one of the movable members passes. The cover member 14 has the effect of suppressing the opening of the movable member 3 moving on the surface of the spherical member 2 such like in a transformation process. The cover member 14 is configured like a chain with a spherical outer periphery connecting all the movable members 3A to 3D. Specifically, the cover member 14 having an initial flat shape connects one of the movable members 3 and another adjacent one of the movable members 3 and connects all the adjacent movable members so as to cover the spherical member 2. The cover member 14 like a chain does not connect the cover member 14 and the ring as curved nodal portion 16 but presses the adjacent rings 16 from the outer periphery (see FIG. 5), allowing the rotations of the pair of movable members 3A and 3B and the movable members 3C and 3D. In this application example, one surface as symbol r of the chain 14 is considered to be resistant to a tensile force applied to the movable member unlike in the first embodiment (see FIG. 11).

According to the present embodiment, a feature of the present embodiment is that the cover member 14 has a larger area with a larger sliding surface or sliding contact surface with the surface of the spherical member 2 than in the first embodiment. Since the cover member 14 is a circular chain member or chain, a tension ring is formed around the spherical member 2, allowing sliding between the spherical member 2 and the chain 14. The present inventor calls such sliding “the relationship of a rotational sliding pair”.

Engagement such protrusion and groove for transmitting a tensile force applied to the movable member needs to be prepared between the cylindrical member 5 and the wing 4. Preferably, the cylindrical member 5 is a protrusion and the wing is a groove in consideration of the thickness of the member.

### Second Embodiment

FIG. 12A shows an example of multi-axis universal joints 11 according to the present embodiment. FIG. 12B is a perspective view showing the component configuration of the universal joint.

The universal joint 11 of the present embodiment includes six large movable members 3A to 3F and six small movable members 3a to 3f, totaling 12 movable members. The number of movable members is not particularly limited and thus may be smaller than or larger than 12.

The large movable members 3A to 3F and the small movable members 3a to 3f each include a cylindrical member containing the movable member 3, a cover member as wing 4 provided around the rod member 3, and the cylindrical member 5 that contains the rod member 3 and the wing 4. The cover member as wing 4 is V-shaped and is fan-shaped in cross section as shown like a spread wing. The movable members 3A to 3F and the small movable members 3a to 3f each have a curved nodal portion as ring 6 near the spherical member. In this configuration, the V-shaped member as wing 4 and the cylindrical member 5 press the curved nodal portion as ring 6 that is provided on the end of the movable member, to the spherical member 2. A fitting portion 4a is provided on the other end of the cylindrical member 5. The curved nodal portion 6 has a concave shape. The center of the curved nodal portion 6 is connected to the rod member 3 and is fitted to the end 4a of the V-shaped wing 4. The range of motion of the spherical member 2 changes depending upon the relationship between the size of the spherical member 2 and the diameter of the movable member, the fan shape of the wing in cross section and center angle, and so on.

The large movable members 3A to 3F and the small movable members 3a to 3f are vertically disposed in pairs with respect to the spherical member 2 and are horizontally spaced at intervals of 90 degree. The movable members 3 are directed to the center of the spherical member 2 and are evenly spaced. The movable members 3 can be radially disposed or disposed with point symmetry or line symmetry with respect to the spherical member 2. Thus, the multiple movable members at equal intervals are efficiently disposed.

For example, if the V-shaped wing 4 and the cylindrical member 5 only press the curved nodal portion as ring 6 of each of the large movable members 3A to 3F to the spherical member 2, only the large movable members 3A to 3F can be rotated.

The curved nodal portions 6 of the large movable members 3A to 3F and the curved nodal portions as rings 6 of the small movable members 3A to 3F can be varied in size so as to change a contact area with the spherical member 2.

The universal joint 31 according to the first embodiment can freely change an angle formed by one spaced consecutive movable members. The second embodiment is composed of the large movable members 3A to 3F and the small movable members 3a to 3f. The relationship among the large movable members 3A to 3F is identical to that can freely change an angle formed by one spaced consecutive movable members, including the small movable members 3a to 3f. Thus, an angle formed by the large movable members can be freely changed.

The second embodiment is applicable to a construction for efficiently constructing a temporarily assembled two-dimensional structure on the ground into a three-dimensional dome such lifting a tent into a dome roof, a bridge, a joint of a structure, and so on.

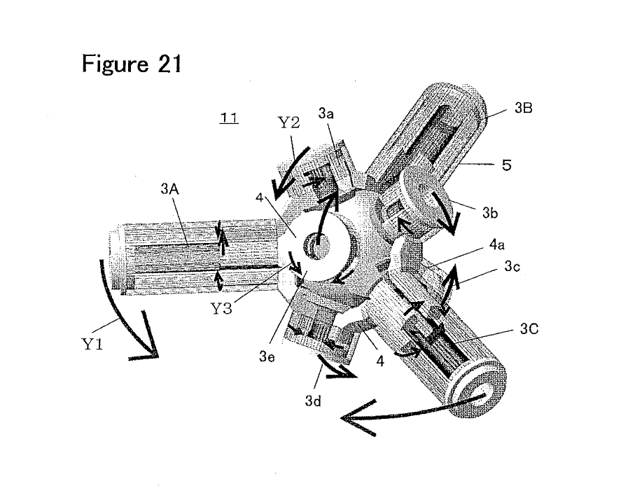

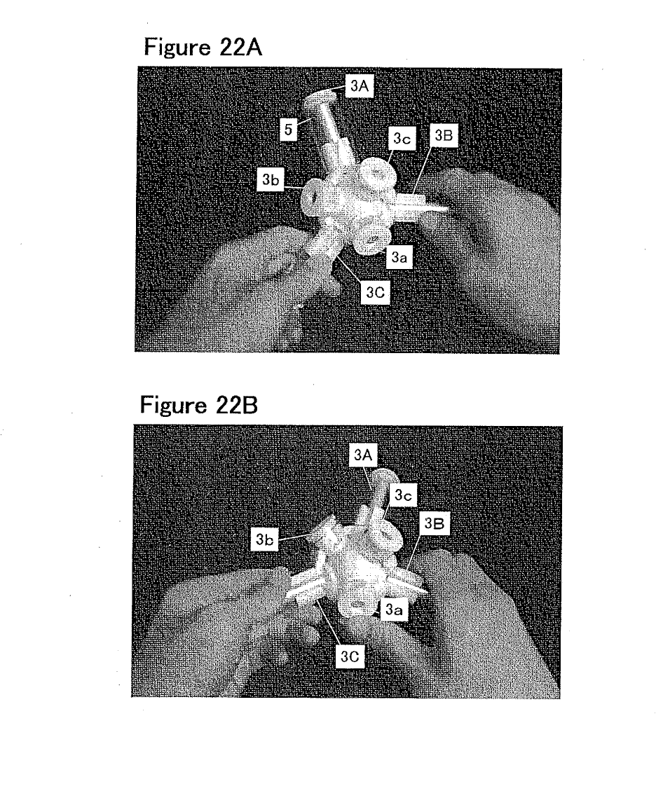

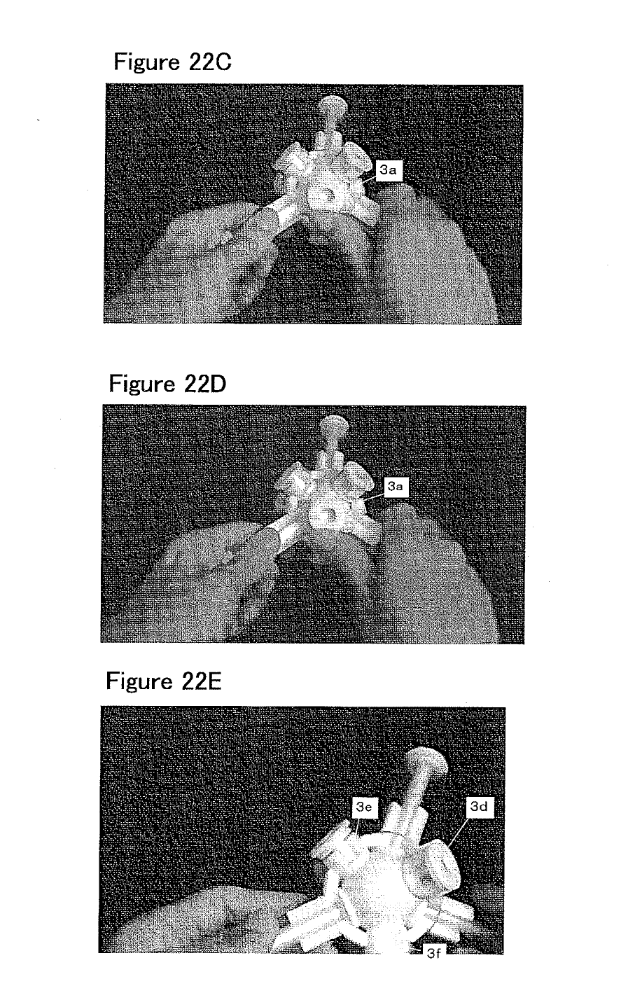

FIG. 21 and FIG. 22A to FIG. 22E show an application example of the second embodiment. The universal joint 11 includes the three long movable members 3A to 3C and the six short movable members 3a to 3f. These movable members are connected at equal intervals via a cover member as wing 4 so as to approach one another or separate from one another. The universal joint 11 of the present embodiment is configured to move the long movable members 3A to 3C. The short movable members 3a to 3f are only used for moving the long movable members 3A to 3C and thus are not connected to other joints. In other words, the connected state of the short movable members 3a to 3f to other joints is a state of a structure including joints connected via spacers S as shown in FIG. 17. The long movable members 3A and 3B constitute the structure including the joints connected via the spacers S as shown in FIG. 17.

The cover members as wings 4 of the present embodiment are connected at predetermined intervals around the respective long movable members 3A to 3C. The length of the cover member allows an end 4a of the cover member to approach the cylindrical member 5 of each of the short movable members 3a to 3f. The cover members are unconnected to allow movements of the six short movable members 3a to 3f and press curved nodal portions q of the six short movable members 3a to 3f from above. Thus, as shown in FIG. 22A to FIG. 22E, the movable members 3A to 3C and 3a to 3f can rotate about the center of the spherical member 2 serving as the center point of rotation. Furthermore, the movable members can move in contact with the outer periphery of the spherical member 2. The cylindrical member 5 and so on of the movable member connected to the cover member as wing 4 is identical to that of the second embodiment.

FIG. 21 shows arrows of motions. If the long movable members 3A to 3C are moved along a long arrow Y1, the short movable members 3a to 3c are rotated along a second longest arrow Y2. Further explaining the second longest arrow Y2 rotation is made with respect to the center point of a sphere. A short arrow Y3 indicates the rotation of the cover member 4. Further explaining the center of rotation of the short arrow Y3 is the central axis of the rod member 3. The movable members are simultaneously rotated by a movement along the long arrow Y1. If the direction of the movement is reversed from the long arrow Y1, the directions of all the arrows are reversed.

Thus, as shown in FIG. 22A to FIG. 22E, the three short movable members 3a to 3c can be moved to the center in this order. In order to move the long movable members 3A and 3B, the three short movable members 3a to 3c are moved to the center as shown in FIG. 22A to FIG. 22E, relocating the long movable members 3A to 3C to the center as one side of the spherical member 2 in a sliding manner. As shown in FIG. 22E, the relocation increases the intervals of the short movable members 3d to 3f on the other side.

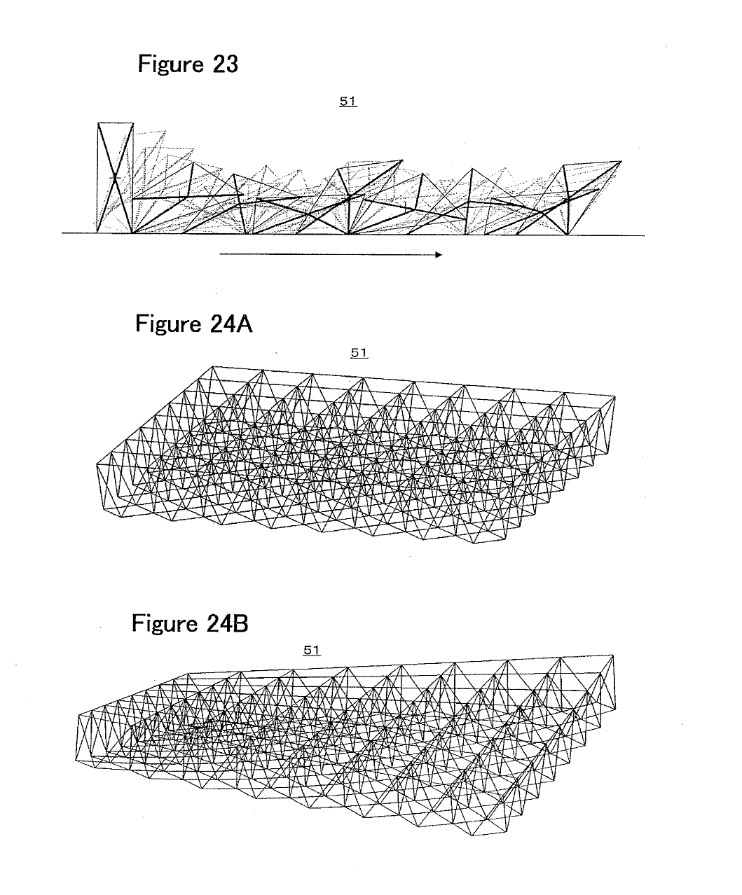

FIG. 23 is an explanatory drawing of motions of an variable structure 51 including the connected universal joints according to the second embodiment. Specifically, FIG. 23 shows an example of a numerical analysis on the variable structure or adjustable movement of the structure 51 that uses the multi-axis universal joint 11 corresponding to FIG. 12A. FIG. 23 sequentially shows the motions. The structure 51 is transformed like amoeba. Further explaining, the rolls with a changing rectangular shape and moves forward from the left to the right in FIG. 23. In this example, a rover is a driving member that travels forward on a bad road and is expected to be developed for motor vehicles that can move under adverse conditions such as roads with long rocks and holes. Programs have been developed to examine the variable structure 51 according to a numerical analysis example on a two-dimensional plane and determine the length of a shaft member as an input value by a numerical analysis. Thus, the examination of the analysis and motions was confirmed.

### Third Embodiment

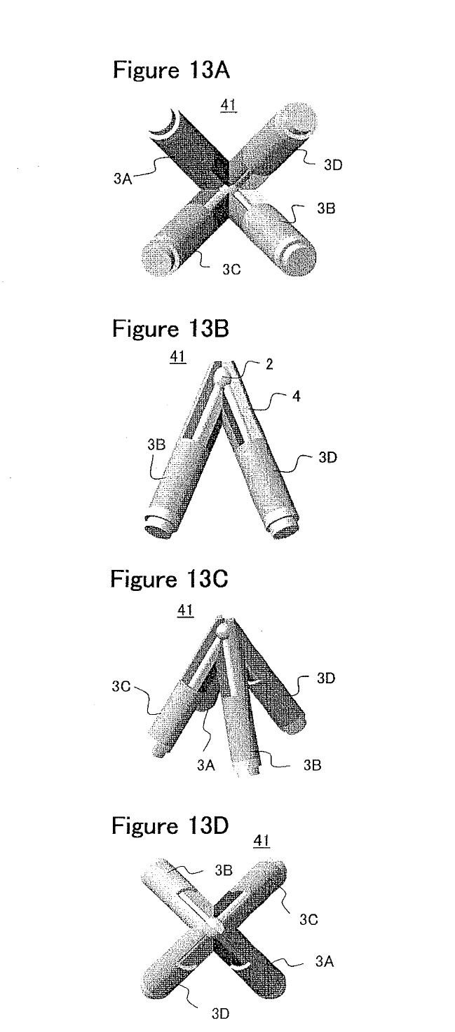

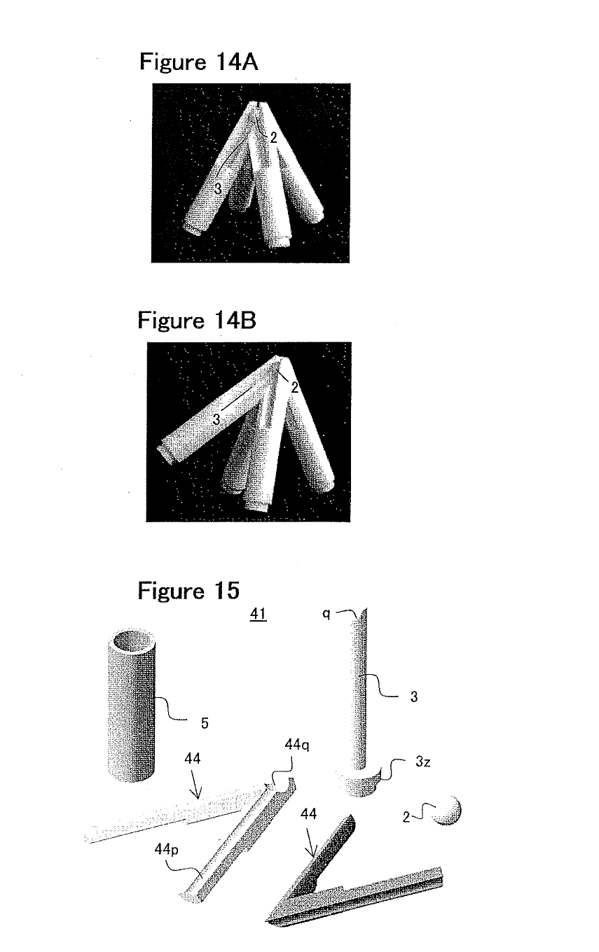

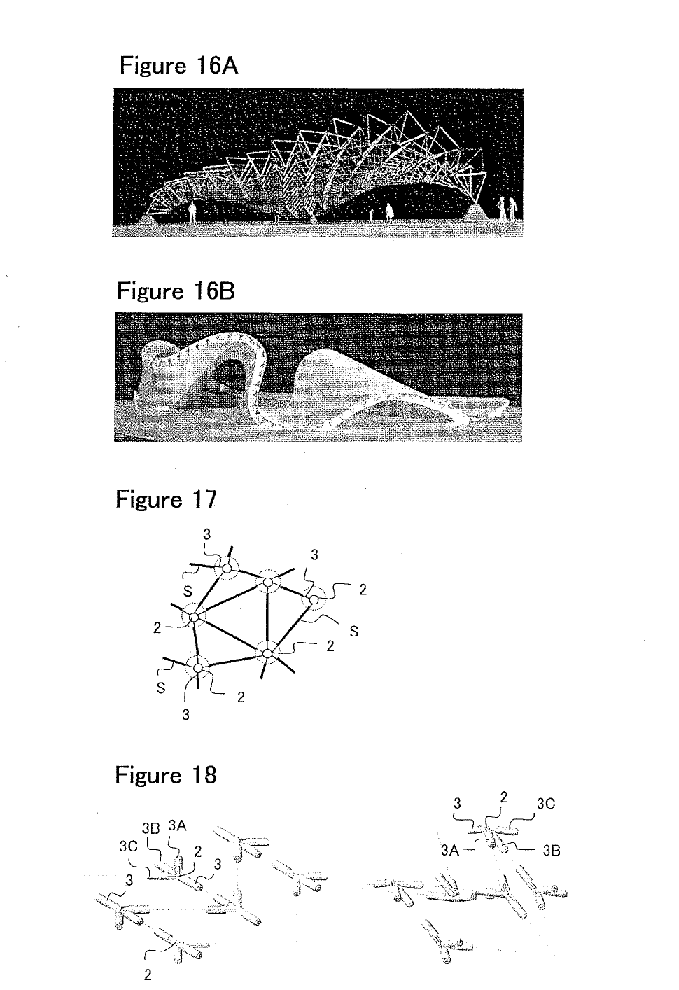

FIG. 13 shows a universal joint 41 according to a third embodiment. FIG. 14 is an explanatory drawing of a driven state. FIG. 15 is a component configuration diagram. FIG. 16 shows an example applied to the ceiling of a construction. The third embodiment is different from the first embodiment in its three-dimensional initial shape.

An application example of the universal joint 41 according to the present embodiment is an adjustable three-dimensional truss frame. In the present embodiment, four movable members 3 as 3A to 3D are disposed at equal intervals with the spherical member 2 located on top of the movable members. The movable members 3A to 3D include cylindrical members 5 that store the respective movable members 3A to 3D, cover members 44 connecting the cylindrical members 5 to each other, and the spherical member 2. The cover member 44 has a curved nodal portion 44q for locating the spherical member 2 on the top of the V shape of the cover member 44, and curved portions 44p for locating the movable members 3 on the left and right sides of the V shape of the cover member 44.

Moreover, the four movable members 3A to 3D at equal intervals are rotated from its positions such that the pair of movable members 3A and 3B (or 3C and 3D) is brought closer to each other or returned to the original positions. A feature of the movable members is that even if these operations are repeated, the curved nodal portion q formed in contact with the spherical member 2 on the ends of the movable members 3A to 3D does not generate a bending moment. Another feature is that the cover member 44 having the curved nodal portion 44q does not generate a bending moment even if the cover member 44 is rotated.

FIG. 15 shows an application example of the universal joint 41 according to the present embodiment. The third embodiment is applicable to a construction for efficiently constructing a temporarily assembled two-dimensional structure on the ground into a three-dimensional dome such lifting a tent into a dome roof, a bridge, a joint of a structure, and so on.

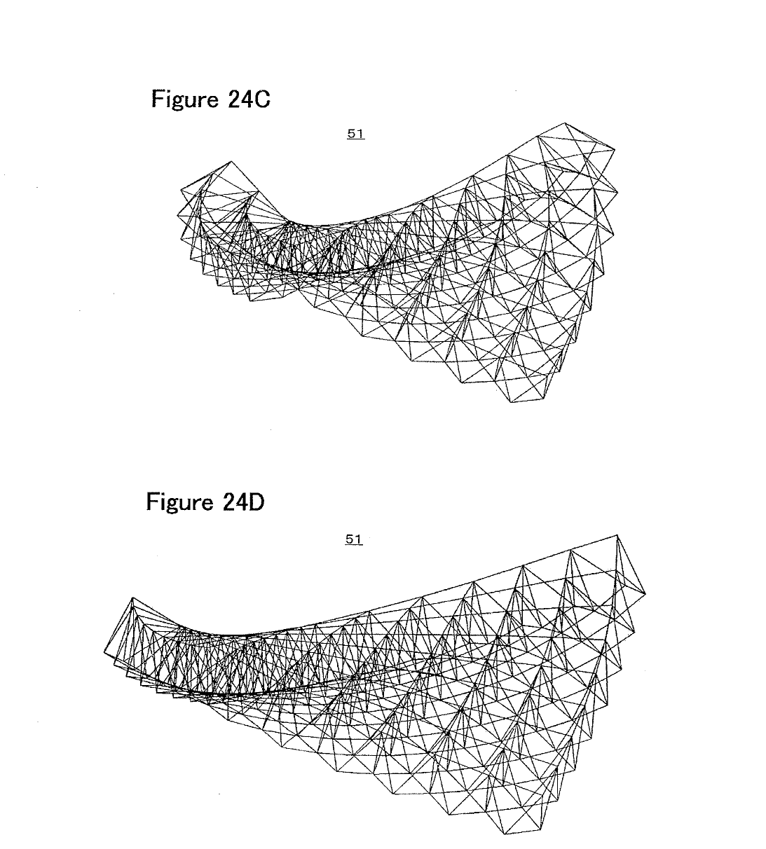

FIG. 24 shows an example of a numerical analysis on the variable structure 52 that uses the universal joint 41 corresponding to a numerical analysis example on the variable structure of FIG. 16A. The variable structure 52 of FIG. 24 can be manufactured using the universal joint 11 of FIG. 5A and the universal joint 21 of FIG. 10A. A morphological analysis program was prepared to trace how the variable structure 52 is transformed into a stable shape. It is verified that a target shape can be designed.

FIG. 17 shows an application example of the third embodiment.

In this application example, a structure uses a connecting member as spacer S that connects the spherical members 2 to each other with the same diameter as the cylindrical member 5. A wing 4 or the cylindrical member 5 does not need to be contained in all lines. The spherical member 2 only needs to be configured around a nodal point. Pipes or rod-like connecting members as spacers connecting nodal points are introduced to form a large number of connecting structures.

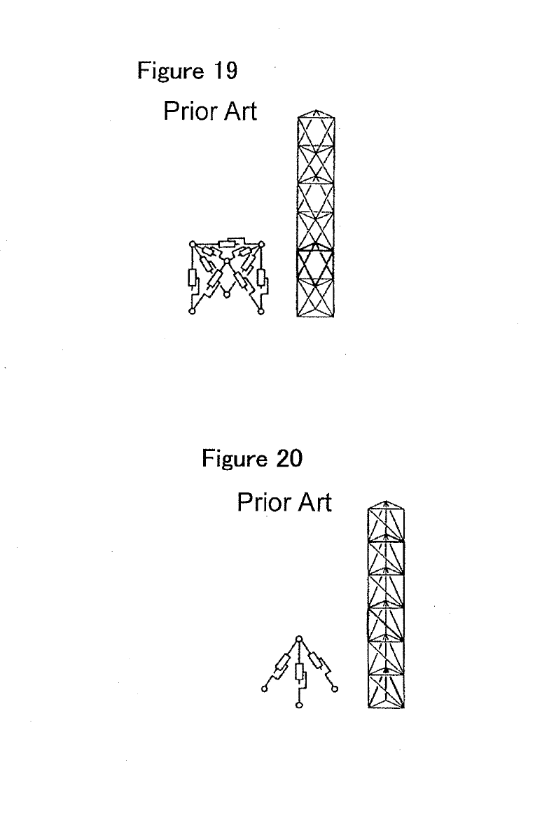

A conventional truss structure is called variable geometry trust (VGT). In a diagram of a VGT, a nodal point having concentrated lines serves as a joint and a multi-axis universal joint is used (see FIG. 19). In the case of a VGT called a helical mast in FIG. 20, a multi-axis universal joint having six axes is used.

It is however quite difficult to achieve such a joint in an actual three-dimensional VGT. Thus, a nodal point offset can not be avoided between the rotation centers of multiple joints that join the members (see the marginal notes of Non-patent Literature).

In contrast, the present embodiment can provide a durable truss structure and avoid the nodal point offset.

FIG. 18 shows another application example of the third embodiment. The spherical member 2 at the top has another movable member 3 according to the third embodiment. In FIG. 18, a universal joint unit is composed of the three movable members 3A to 3C, each having the spherical member 2 on the top, and the movable member 3. In this configuration, the three movable members 3A to 3C are disposed at the intervals of 60 degree and the additional movable member 3 and the movable members 3A and 3C are disposed at the intervals of 120 degree. Furthermore, the movable members 3A to 3C can be driven by a predetermined angle with respect to the movable member 3 via the spherical member 2. The multiple movable members in a connected state are applied to, for example, a truss structure for a construction.

The foregoing embodiments described building structures as specific examples, but the embodiments may be applied as follows:

### (Construction)

The embodiments are applicable to transformed constructions such as a variable structure and a developed structure unlike a conventional static construction. The embodiments are applicable to a construction for efficiently constructing a temporarily assembled two-dimensional structure on the ground into a three-dimensional dome in a construction process. Preferably, a developed structure has a rigid surface with mechanism properties such as a constant surface area and a varying internal volume. Moreover, constructions specifically for designs having organic forms can be efficiently produced by a uniform component configuration. For example, joints for constructions requiring multi-axis pin joints can be produced. Such constructions with expandability take advantage of free nodal points. Furthermore, such constructions are usable as damping/base isolation. Because of its free nodal points, such constructions are effective for active damping techniques involving transformation of structures.

### (Machine)

A machine operation (steering) technique is considered to be effective in the case where multiple operation targets are three-dimensionally provided. A mechanism for transmitting the motions of multiple members can be achieved by a small number of members. This technique is applicable to the joints of a parallel-link mechanism having multiple links, a flight simulator, and so on.

This technique is applicable to robots using curving motions like geometers (Multi-legged walking creature) instead of robots operated by a serial link mechanism with robot hands and legs. Direct acting control can achieve efficient robots unlike in torque control. This technique is also applicable to a device for damping an impact on a surface. Since spacers S are springs, large sporting apparatuses such as a trampoline can be provided. Furthermore, this technique is widely applicable to apparatuses for precisely keeping the coordinate position of a target of base isolation, medical technology, and so on in combination with a base isolating device for vibrations in multiple directions and a system control technique.

### (Engineering Works)

The embodiments are applicable to, for example, the joints of structures such as bridges requiring multi-axis pin joints. Such structures as bank protection works or temporary works take advantage of tracking performance on irregular shapes of natural objects.

### (Space Structure)

The embodiments are applicable to developed structures with adjusting performance, solar panels, and so on. Such structures have free nodal points and thus can be easily extended into structures for a space station.

### (Other Applications)

The embodiments are applicable to various products such as the joints of toys, products having folding structures, and products using adjustable mechanisms.

1. A universal joint, comprising:
a plurality of movable members; a spherical member that links the movable members;
a cover member that brings the movable members into contact with the spherical member;
wherein the movable member has a curved nodal portion in contact with the spherical member, and any one of the movable members is moved or rotated along the surface of the spherical member with the curved nodal portion.

2. The universal joint according to claim 1, wherein the curved nodal portion of the movable member is larger in diameter than the movable member and the cover member is movable or rotatable along the surface of the curved nodal portion.

3. The universal joint according to claim 1, wherein the movable members include at least two pairs of members: a first pair of movable members and a second pair of movable members, and the cover member includes a first cover member that brings one of the movable members of the first pair and the other movable member of the second pair into contact with the spherical member, and a second cover member that brings the other movable member of the first pair and one of the movable members of the second pair into contact with the spherical member.

4. The universal joint according to claim 1, further comprising:
a cylindrical member covering each of the movable members;
wherein the cylindrical member is connected that is allowed a rotation of the cover member.

5. The universal joint according to claim 1, wherein the movable members are disposed radially around the spherical member, or the movable members are disposed with point symmetry around the spherical member, or the movable members are disposed with line symmetry around the spherical member.

6. The universal joint according to claim 1, wherein one of the movable members is rotated and other movable member is moved or rotated with around the spherical member, or one of the movable members is rotated and other movable members are moved or rotated with around the spherical member.
